(19) United States
(12) Patent Application Publication
(10) Pub. No.: US 2008/0173702 A1
(43) Pub. Date: Jul. 24, 2008

(54) MAGNETIC CARD AND ENVELOPE

(76) Inventor: Laurel Grace Meister, Laguna Beach, CA (US)

Correspondence Address: DOBRUSIN & THENNISCH PC, 29 W LAWRENCE ST, SUITE 210, PONTIAC, MI, 48342, US

(21) Appl. No.: 12/033,966

(22) Filed: Feb. 20, 2008

Related U.S. Application Data
(62) Division of application No. 11/327,619, filed on Jan. 6, 2006.
(60) Provisional application No. 60/642,296, filed on Jan. 7, 2005.
(60) Provisional application No. 60/684,039, filed on May 24, 2005.

(51) Int. Cl. B65D 27/12; B65D 27/00; B31B 1/90; B65D 71/00

(52) U.S. Cl. 229/78.2; 229/74; 493/214; 206/575

(57) ABSTRACT

The present invention is a magnetic card and/or envelope that can be removeably attached to a package. The present invention also includes methods for making the magnetic card and envelope and a gift wrapping kit comprising the magnetic card or envelope along with a package.

### CLAIM OF BENEFIT OF FILING DATE

This application is a divisional of U.S. patent application Ser. No. 11/327,619 filed on Jan. 6, 2006 which claims the benefit of U.S. Provisional Application No. 60/642,296 titled: “Magnetic Card” filed on Jan. 7, 2005 and U.S. Provisional Application No. 60/684,039 titled: “Magnetic Envelope” filed on May 24, 2005.

### FIELD OF THE INVENTION

This invention generally relates to an improved card, tag, label and envelope having a magnetic device that allows such device to be removeably attached to a package.

### BACKGROUND OF THE INVENTION

Traditionally, a package is accompanied by a card, tag, or label that provides certain information regarding the donor and/or receiver (e.g., greetings, donor's identity, recipient's identity, store identity etc.) In fact, when giving or receiving a package, it is customary to identify the donor prior to opening the package. With the increased popularity of utilizing a gift bag as the package or wrapping, a problem exists in identifying the donor. A conventional gift bag is generally sold with a small tag attached to its handle. This tag is generally not large enough to convey any thoughts other than gift donor's identity and gift recipient's identity and cannot be removed for posterity without compromising the condition of the tag or the gift bag or both. Furthermore, the tag can only be used once, then, should one want to reuse the accompanying gift bag, she will either have no tag, or she must use an alternative means (e.g., another tag, label, card or the like).

Use of the conventional greeting card poses the problem of how to attach such card to the exterior of the package (desirable for easy access and viewing). Attaching the card to the outside of the package with adhesive will likely damage the card (or the envelope in which the card is contained), the package, or both. With no easy means of attaching to a package, the card usually gets placed inside the package resulting in a loss of easy access. Furthermore, if the package is a gift bag, the card is also likely to be lost in wrapping paraphernalia (e.g., tissue paper, etc.) thereby requiring the gift recipient to search for the card inside the gift bag.

An additional problem with conventional greeting cards, tags and labels is that each of them can be easily detached from the package resulting in loss of information to the recipient.

### SUMMARY OF THE INVENTION

The present invention solves these problems by providing a magnetic card, tag, label (hereinafter referred to as “card”) and/or envelope that is readily accessible and securely but removeably attached to a package. The present invention is a magnetic card comprising of a substrate having at least two outward facing surfaces, a first magnet attached to a first inward facing surface of the substrate, a second magnet attached to a second inward facing surface of the substrate in a location that allows said second magnet to be attracted and attached to said first magnet thereby forming the magnetic card that can be removeably attached to a package.

The present invention also includes a method for making a magnetic card comprising: providing a substrate having at least two outward facing surfaces; attaching a first magnet to a first inward facing surface of said substrate; attaching a second magnet to a second inward facing surface of said substrate in a location on said second inward facing surface that allows said second magnet to be attracted and attached to said first magnet thereby forming a magnetic card that can be removeably attached to a package.

The present invention includes a gift wrapping kit comprising: the above-described magnetic card and the package.

The present invention also includes a magnetic envelope comprising of an envelope having a front panel, a flap, a rear panel, closed ends and an interior portion; a first magnet attached to the flap, a second magnet attached to the rear panel in a location on said rear panel that allows said second magnet to be attracted and attached to said first magnet thereby forming the magnetic envelope that can be removeably attached to a package.

The present invention further includes a method for making a magnetic envelope comprising: providing an envelope having a front panel, a flap, a rear panel, closed ends and an interior portion; attaching a first magnet to the flap; attaching a second magnet to the rear panel in a location on said rear panel that allows said second magnet to be attracted and attached to said first magnet thereby forming a magnetic envelope that can be removeably attached to a package.

The present invention includes a gift wrapping kit comprising: the above-described magnetic envelope and the package.

Since the present invention can be removed from the package without compromising the condition of either itself and/or the package, reuse of packaging material is provided. The use of magnets, unlike adhesive or other means, do not lose their ability to securely fasten after repeated use. Furthermore, the present invention has the ability to be a larger size than a conventional tag that comes with a gift bag or box, thereby providing more space for information or sentiments to be disclosed. The present invention can be used as a further decoration for the package, adding to the overall aesthetics. The present invention can attach securely, effortlessly, and is less likely to become detached from the package resulting in lost information, sentiment and/or identity.

### BRIEF DESCRIPTION OF THE DRAWINGS

The features and inventive aspects of the present invention will become more apparent upon reading the following detailed description, claims, and drawings, of which the following is a brief description:

FIG. 1 is an exterior view of one embodiment of a magnetic card in accordance to the principles of the present invention;

FIG. 2 is an interior view of the embodiment shown in FIG. 1;

FIG. 3 is a perspective view of another embodiment of a magnetic card in accordance to the principles of the present invention;

FIG. 4 is a perspective view of the embodiment shown in FIG. 1 attached to a gift bag;

FIG. 5 is a perspective view of the embodiment shown in FIG. 1 attached to a handle of a gift bag;

FIG. 6 is a perspective view of the embodiment shown in FIG. 1 attached to a slot of a gift bag;

FIG. 7 is a perspective view of the embodiment shown in FIG. 1 attached to a package by its ribbon.

FIG. 8 is another perspective view of the embodiment shown in FIG. 1 attached to a package by its ribbon.

FIG. 9 is a perspective view of the embodiment shown in FIG. 1 attached to a slot within a package;

FIG. 10 is a perspective view of another embodiment of a magnetic card in accordance with the principles of the present invention shown attached to a gift bag;

FIG. 11 is a perspective view of another embodiment of a magnetic card in accordance with the principles of the present invention;

FIG. 12 is a perspective view of another embodiment of a magnetic card in accordance with the principles of the present invention shown attached to a gift bag;

FIG. 13 is a perspective view of yet another embodiment of a magnetic card in accordance with the principles of the present invention;

FIG. 14 is a perspective view of another embodiment of a magnetic card in accordance with the principles of the present invention;

FIG. 15 is a perspective view of one embodiment of a magnetic envelope in accordance to the principles of the present invention;

FIG. 16 is a perspective view of another embodiment of a magnetic envelope in accordance to the principles of the present invention;

FIG. 17 is a perspective view of the embodiment shown in FIG. 15 attached to a gift bag;

FIG. 18 is a perspective view of the embodiment shown in FIG. 15 attached to a handle of a gift bag;

FIG. 19 is a perspective view of the embodiment shown in FIG. 15 attached to a slot of a gift bag;

FIG. 20 is a perspective view of the embodiment shown in FIG. 15 attached to a package by its ribbon;

FIG. 21 is another perspective view of the embodiment shown in FIG. 15 attached to a package by its ribbon;

FIG. 22 is a perspective view of the embodiment shown in FIG. 15 attached to a slot within a package; and

FIG. 23 is a perspective view of another embodiment of a magnetic envelope in accordance with the principles of the present invention shown attached to a gift bag.

### DETAILED DESCRIPTION OF THE PREFERRED EMBODIMENT

The present invention is predicated upon providing a card, tag or label that uses magnetic forces to removablely attach itself to a package. The present invention is also predicated upon providing an envelope that uses magnetic forces to removablely attach itself to a package.

I. Glossary

The following terms are intended to have the following general meanings as they are used herein.

1. Card: any card, tag or label.

2. Envelope: any container or holder for a written message such as a note or card. The envelope can be constructed by any suitable art-disclosed methods.

3. Package: any bag, box, material, wrapping paraphernalia (e.g., paper, ribbons, or the like) suitable for containing a gift, an object or the like. It can be constructed of any suitable art-disclosed materials, paper, plastics, plastic derivatives, metal, metal alloys, wood, fabric, glass, or any combination thereof.

4. Paper: paper of any weight, cardboard or the like.

II. The Magnetic Card

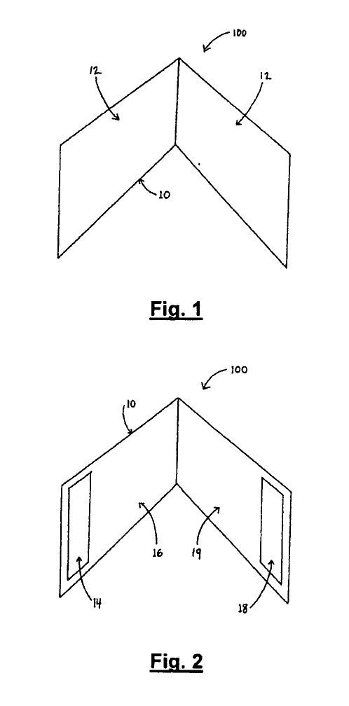

Referring to FIGS. 1, 2 and 4, a preferred embodiment of the present invention is shown and comprises at least one substrate 10 having at least two outward facing surfaces 12, a first magnet 14 attached to a first inward facing surface 16 of the substrate 10, a second magnet 18 attached to a second inward facing surface 19 of the substrate in a location that allows said second magnet 18 to be attracted and attached to said first magnet 14 thereby forming the magnetic card 100 that can be removeably attached to a package 20.

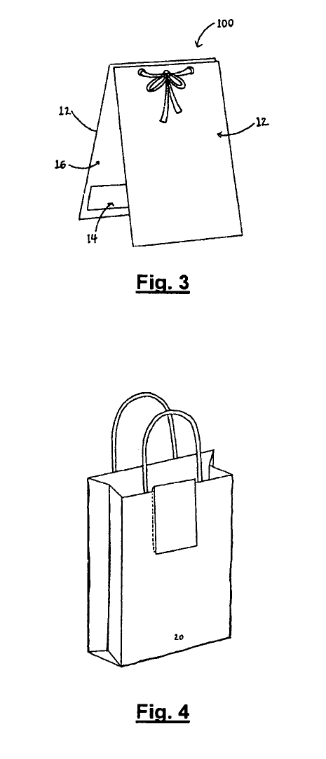

The substrate 10 can be constructed out of any art-disclosed suitable material such as paper, plastics, plastic derivatives, metal, metal alloys, wood, fabric, glass, and a combination thereof. The substrate 10 can be any predetermined size and/or shape (e.g., square, rectangular, circle, diamond, triangle, irregular, etc) suitable for its purpose. For example, the substrate can be a 10″×3″ cardboard that can be folded into a 5″×3″ size card. The substrate 10 can be formed by a single planar material containing a fold as shown in FIG. 1 or a plurality of materials attached together at one end as shown in FIG. 3. The means for such attachment can be provided by any suitable art-disclosed means such as adhesive, string, stitching, magnets, buttons, snaps, staples, or a combination thereof.

The magnets (14, 18) can be of any suitable shape. Furthermore, the present invention is not limited to the two magnets (14, 18), it may include the use of more than two magnets. For example, as an alternative embodiment of the present invention, the first inward facing surface (16) can have two magnets that are attracted and attached to another two magnets attached to the second inward facing surface (19).

The card 100 can be optionally decorated with a decoration such as writing, ornamental design, two dimensional art, three dimensional art, printing, embossing, stamping, glittering, painting, button, gem, collage of die cut papers, collage of objects of any material, photograph, sticker, pressed flower, other object from nature, bead, string, fabric or a combination thereof.

It is contemplated that alternatives to the components and aspects of the card 100 may be employed in the practice of the present invention. Some of those alternatives are disclosed below, however, the skilled artisan will appreciate that many other alternatives may also be employed as well in the practice of the present invention.

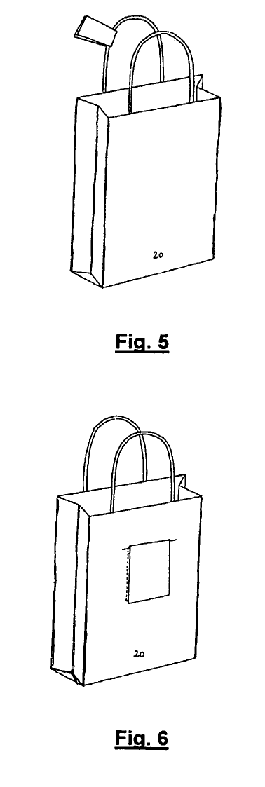

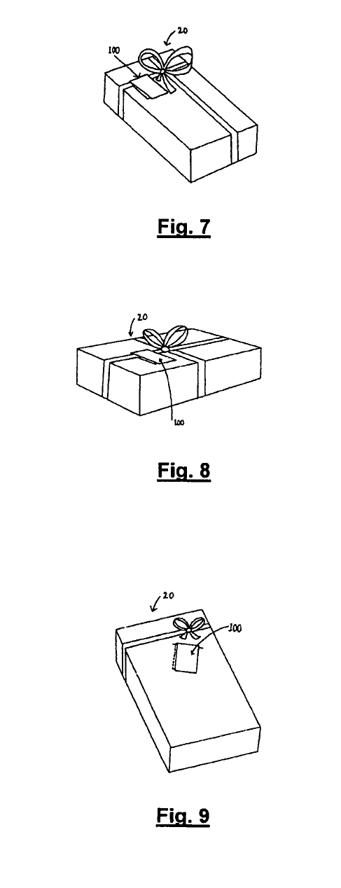

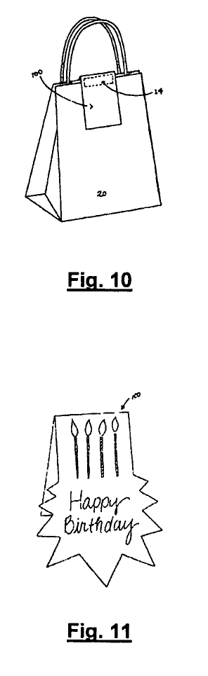

The card 100 can be used to label a variety of different packages, in a variety of different ways. For example, the card 100 can be removably attached by folding it over top edge of a bag (20) as showed in FIG. 4, fold it over the handle of the bag (20) as shown in FIG. 5, or placed into a slot of the bag (20) as shown in FIG. 6. On a conventionally wrapped package, the card 100 can be removeably attached through the loops of a bow or ribbon or string of the package 20 as shown in FIGS. 7-8, or placed into a slot in the package 20 as shown in FIG. 9. Alternatively and referring to FIG. 10, the card 100 can be removeably attached by folding it over top edge of the bag (20) as shown in FIG. 10 with the magnets (14, 18) of the card 100 also serving the function of closing the bag (20).

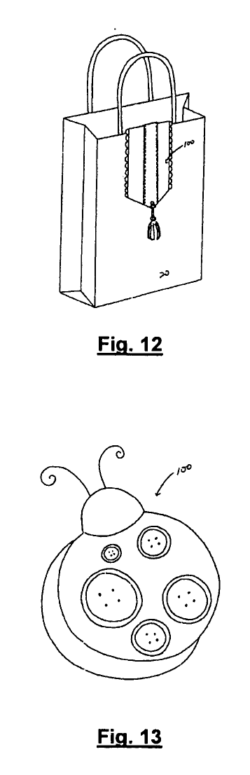

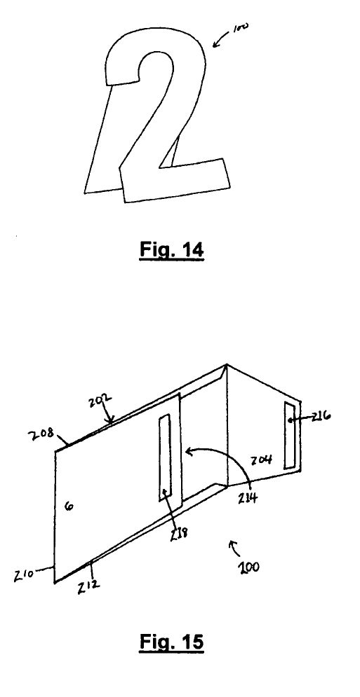

Referring to FIGS. 11-14 are additional embodiments of the card 100 having different shapes and decorations shown either alone or attached to the package 20.

III. The Magnetic Envelope

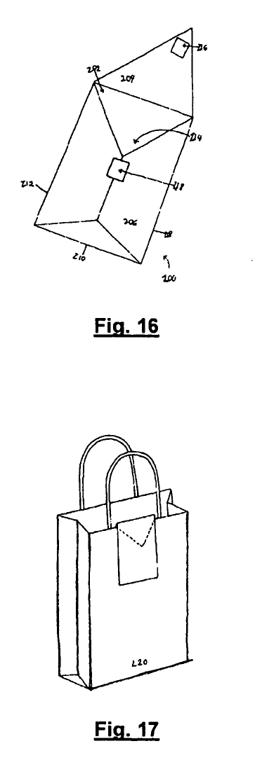

Referring to FIG. 15, a preferred embodiments of the present invention is shown and comprises an envelope 200 having a front panel 202, a flap 204, a rear panel 206, closed ends (208, 210, 212) and an interior portion 214; a first magnet 216 attached to the flap 204, a second magnet 218 attached to the rear panel 206 in a location on said rear panel 206 that allows said second magnet 218 to be attracted and attached to said first magnet 216 thereby forming the magnetic envelope 200 that can be removeably attached to a package 220. Another embodiment of the envelope 200 is shown in FIG. 16.

The envelope 200 can be constructed out of any art-disclosed suitable material such as paper, plastics, plastic derivatives, metal, metal alloys, wood, fabric, glass, and a combination thereof. The envelope 200 can be any predetermined size and/or shape (e.g., square, rectangular, circle, diamond, triangle, irregular, etc) suitable for its purpose. The envelope 200 can be formed by a single planar material as shown in FIGS. 15-16 or a plurality of materials attached together. The means for such attachment can be provided by any suitable art-disclosed means such as adhesive, string, stitching, magnets, buttons, snaps, staples, or a combination thereof.

The magnets (216, 218) can be of any suitable shape. Furthermore, the present invention is not limited to the two magnets (216, 218), it may include the use of more than two magnets. For example, as an alternative embodiment of the present invention, the flap (204) can have two magnets that are attracted and attached to another two magnets attached to the rear panel 206.

The envelope 200 can be optionally decorated with a decoration such as writing, ornamental design, two dimensional art, three dimensional art, printing, embossing, stamping, glittering, painting, button, gem, collage of die cut papers, collage of objects of any material, photograph, sticker, pressed flower, other object from nature, bead, string, fabric or a combination thereof.

It is contemplated that alternatives to the components and aspects of the envelope 200 may be employed in the practice of the present invention. Some of those alternatives are disclosed below, however, the skilled artisan will appreciate that many other alternatives may also be employed as well in the practice of the present invention.

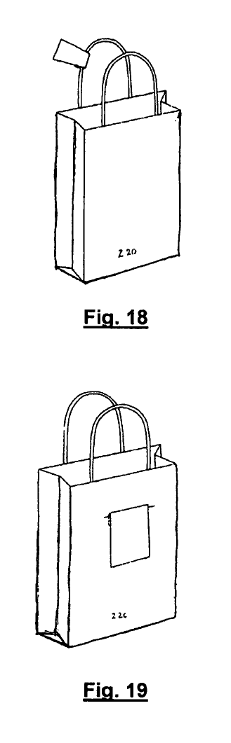

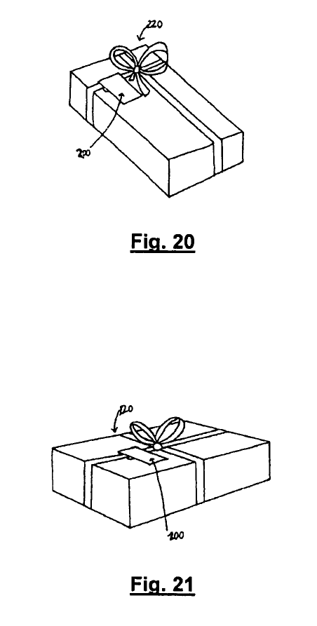

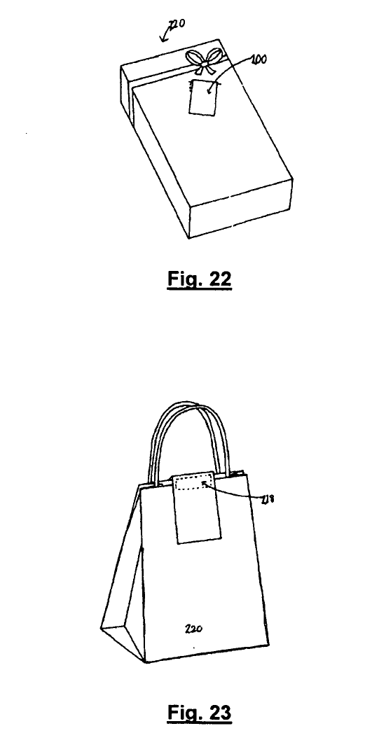

The envelope 200 can be used for a variety of different packages, in a variety of different ways. For example, the envelope 200 can be removably attached by folding it over top edge of a bag (220) as showed in FIG. 17, fold it over the handle of the bag (220) as shown in FIG. 18, or placed into a slot of the bag (220) as shown in FIG. 19. On a conventionally wrapped package, the envelope 200 can be removeably attached through the loops of a bow or ribbon or string of the package 220 as shown in FIGS. 20-21, or placed into a slot in the package 220 as shown in FIG. 22. Alternatively and referring to FIG. 23, the envelope 200 can be removeably attached by folding it over top edge of the bag (220) with the magnets (216, 218) of the envelope 200 also serving the function of closing the bag (220).

The preferred embodiments of the present invention have been disclosed. A person of ordinary skill in the art would realize however, that certain modifications would come within the teachings of this invention. Therefore, the following claims should be studied to determine the true scope and content of the invention.

What is claimed is:

1. A magnetic envelope comprising:
an envelope having a front panel, a flap, a rear panel, closed ends, and an interior portion;
a first magnet attached to said flap,
a second magnet attached to said rear panel in a location on said rear panel that allows said second magnet to be attracted and attached to said first magnet thereby forming a magnetic envelope that can be removeably attached to a package.

2. The envelope according to claim 1 wherein said envelope is constructed of a material selected from the group consisting of paper, plastics, plastic derivatives, metal, metal alloys, wood, fabric, glass, and a combination thereof.

3. The envelope according to claim 1 wherein said envelope is selected from the group consisting of a single planar material containing a fold and a plurality of materials attached together at said closed ends.

4. The envelope according to claim 1 wherein said attachment is provided by means selected from the group consisting of adhesive, string, stitching, magnet, button, snap, staple, and a combination thereof.

5. The envelope according to claim 1 wherein at least one of said panels contains at least one decoration selected from the group consisting of writing, ornamental design, two dimensional art, three dimensional art, printing, embossing, stamping, glittering, painting, button, gem, collage of die cut papers, collage of objects of any material, photograph, sticker, pressed flower, other object from nature, bead, string, fabric, and a combination thereof.

6. An envelope according to claim 1 wherein said flap and said rear panel include additional magnets.

7. An envelope according to claim 1 wherein said envelope's shape is selected from the group consisting of square, rectangular, circle, diamond, triangle and irregular.

8. A method for making a magnetic envelope comprising:
Providing an envelope having a front panel, a flap, a rear panel, closed ends, and an interior portion;
Attaching a first magnet attached to said flap,
Attaching a second magnet attached to said rear panel in a location on said rear panel that allows said second magnet to be attracted and attached to said first magnet thereby forming a magnetic envelope that can be removeably attached to a package.

9. A gift wrapping kit containing:
A magnetic envelope comprising
an envelope having a front panel, a flap, a rear panel, closed ends, and an interior portion;
a first magnet attached to said flap,
a second magnet attached to said rear panel in a location on said rear panel that allows said second magnet to be attracted and attached to said first magnet; and
A package

10. A gift wrapping kit according to claim 9 wherein said package is selected from a group consisting of a bag, a box, wrapping paraphernalia, and a combination thereof.

11. The gift wrapping kit according to claim 9 wherein said package includes a slot used for the attachment of said magnetic envelope.

12. The gift wrapping kit accordingly to claim 9 wherein said package is comprised of a box and a ribbon and said magnetic envelope can be removeably attached to said ribbon.
